(19) United States
(12) Patent Application Publication
(10) Pub. No.: US 2023/0160454 A1
(43) Pub. Date: May 25, 2023

(54) VIBRATION CANCELING METHOD, APPARATUS AND PROGRAM

(71) Applicant: NIPPON TELEGRAPH AND TELEPHONE CORPORATION, Tokyo (JP)

(72) Inventors: Kazunori KOBAYASHI, Tokyo (JP); Masahiro FUKUI, Tokyo (JP)

(73) Assignee: NIPPON TELEGRAPH AND TELEPHONE CORPORATION, Tokyo (JP)

(21) Appl. No.: 17/919,695

(22) PCT Filed: Apr. 24, 2020
(86) PCT No.: PCT/JP2020/017605

§ 371 Date: Oct. 18, 2022

(51) Int. Cl. F16F 15/00; G10K 11/178; F16F 15/02

(52) U.S. Cl. CPC F16F 15/002; G10K 11/17823; G10K 11/17825; G10K 11/17881; F16F 15/02; G10K 2210/3026; G10K 2210/3027; G10K 2210/3028; G10K 11/17817; G10K 2210/3044; G10K 2210/3012

(57) ABSTRACT

A vibration cancellation method is a vibration cancellation method for canceling vibration arriving at a seat from outside of the seat, the vibration being transmitted to a user seated in the seat. The method includes canceling, by a vibration cancellation unit (4), a vibration by outputting a cancellation signal from a position close to a position where user's head is placed when a user is seated, the cancellation signal being obtained based on a reference signal and an error signal. The reference signal is obtained by a vibration sensor (2) disposed in a position close to a vibration source outside the seat in the seat, and the error signal is obtained by an error vibration sensor (3) disposed in the position close to the position where user's head is placed when the user is seated in the seat.

### TECHNICAL FIELD

The present invention relates to an active vibration cancellation technology that suppresses, by using an actuator, an exciter, or the like, vibration generated in a vehicle seat of an aircraft, a railroad, a ship, or a car, a bed in a building, and the like.

### BACKGROUND ART

FIG. 8 illustrates a configuration of the related art disclosed in NPL 1. A reference microphone 102 for observing noise in a space and an error microphone 103 installed around a position where a user want to make a quiet space are included, and a sound cancellation unit 104 is installed. The sound cancellation unit 104 is a secondary sound source that outputs a sound having a phase opposite to a noise and canceling the noise at the position of the error microphone 103.

A cancellation filter unit 108 filters a signal x₂(t) picked up by the reference microphone 102 to obtain an input signal d₂′(t) to the sound cancellation unit 104. The estimated secondary path filter unit 105 filters the signal x₂(t) picked up by the reference microphone 102 to generate a reference signal x₂′(t) to be output to an adaptive algorithm unit 107. An adaptive algorithm unit 101 uses an LMS, an NLMS, a projection algorithm, or an RLS algorithm to sequentially obtains a filter coefficient of a cancellation filter from the reference signal x₂′(t) and an error signal e(t) picked up by the error microphone 103. The obtained cancellation filter coefficient is set in the cancellation filter unit 108.

### CITATION LIST

### Non Patent Literature

NPL 1: Masaharu Nishimura, Yoshinobu Kajikawa, “Chapter 6 Active Noise Control,” [online], The Institute of Electronics, Information and Communication Engineers, “Knowledge Forest” Group 2—Volume 6—Chapter 6, [retrieved on Mar. 31, 2020], Internet <URL:www.ieice-hbkb.org/files/02/02gun_06hen_06.pdf>

### SUMMARY OF THE INVENTION

### Technical Problem

Although noise propagating in the air can be reduced using the scheme described in the Background Art, vibration transmitted through a housing cannot be reduced. In the case of sleeping seats and beds such as seats of an aircraft, vibration interferes with good sleep.

An object of the present invention is to provide a vibration cancellation method, apparatus, and program for canceling vibration of a seat or a bed.

### Means for Solving the Problem

A vibration cancellation method according to one aspect of the present invention is a vibration cancellation method for canceling vibration arriving at a seat from outside of the seat, the vibration being transmitted to a user seated in the seat. The vibration cancellation method includes: by a vibration cancellation unit, outputting, to cancel the vibration, a cancellation signal from a position close to a position where user's head is placed when the user is seated, the cancellation signal being obtained based on a reference signal and an error signal, the reference signal being obtained by a vibration sensor disposed at a position close to a vibration source outside the seat in the seat, the error signal being obtained by an error vibration sensor disposed at the position close to the position where user's head is placed when the user is seated in the seat.

### Effects of the Invention

It is possible to cancel vibration of a seat or a bed.

### BRIEF DESCRIPTION OF DRAWINGS

FIG. 1 is a diagram illustrating an example of a functional configuration of a vibration cancellation apparatus according to a first embodiment.

FIG. 2 is a diagram illustrating an example of a processing procedure of a cancellation method.

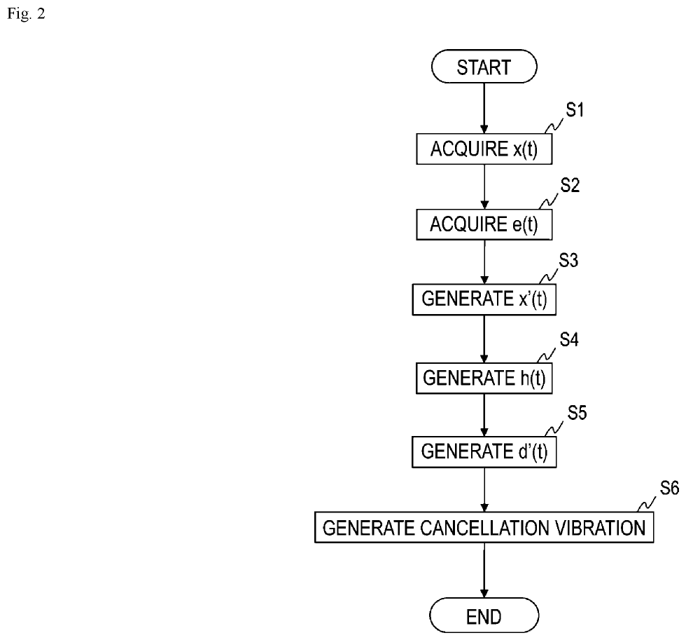

FIG. 3 is a diagram illustrating an example of a functional configuration of a vibration cancellation apparatus according to a second embodiment.

FIG. 4 is a diagram illustrating an example of a functional configuration of a vibration cancellation apparatus according to a third embodiment.

FIG. 5 is a diagram illustrating an example of a functional configuration of a vibration cancellation apparatus according to a fourth embodiment.

FIG. 6 is a diagram illustrating an example of a functional configuration of a vibration cancellation apparatus according to a fifth embodiment.

FIG. 7 is a diagram illustrating an example of a functional configuration of a computer.

FIG. 8 is a diagram illustrating an example of a functional configuration of a vibration cancellation apparatus according to the Background Art.

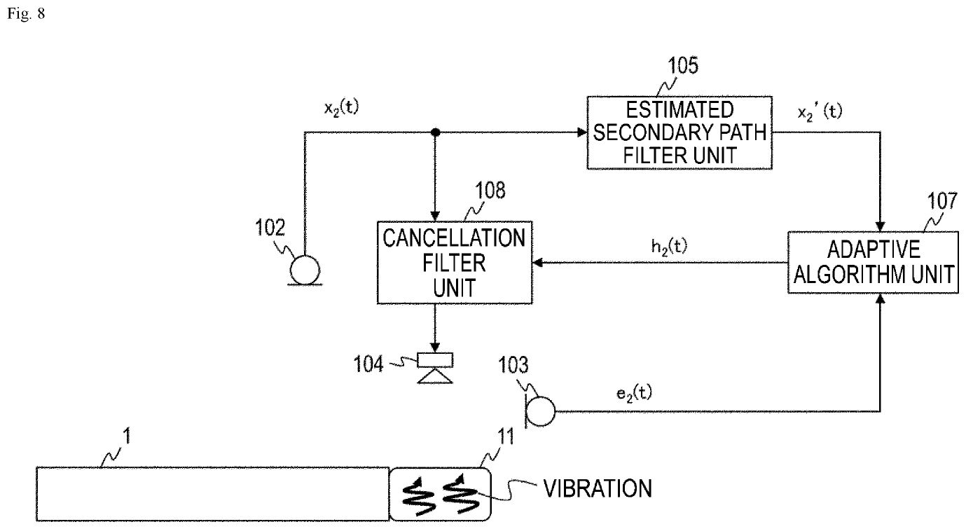

### DESCRIPTION OF EMBODIMENTS

Hereinafter, embodiments of the present invention will be described in detail. In the drawings, components having the same function are denoted by the same reference signs, and repeated description will be omitted.

### First Embodiment

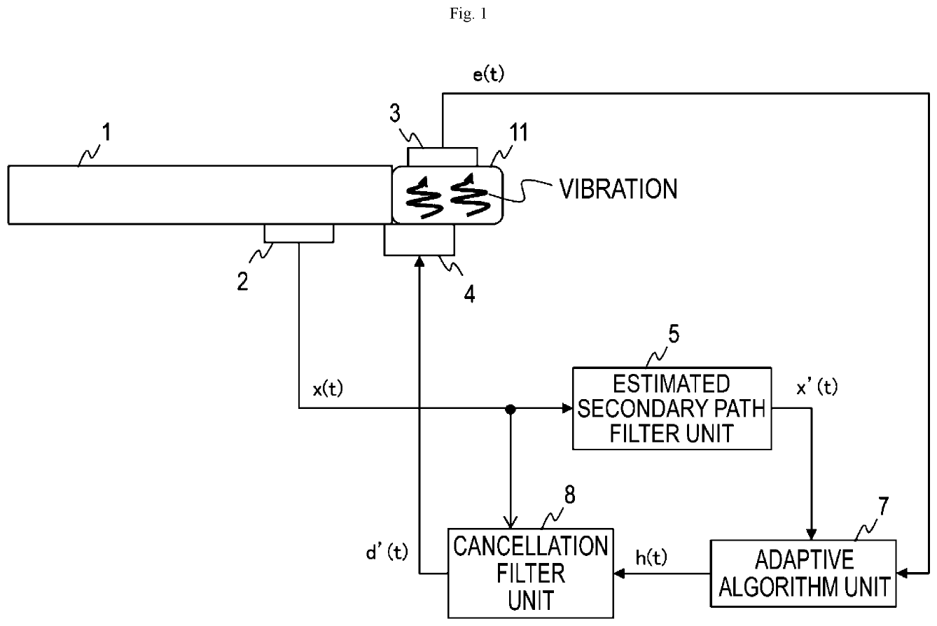

FIG. 1 is a configuration diagram illustrating an example of a vibration cancellation apparatus according to a first embodiment. The vibration cancellation apparatus of the first embodiment includes, for example, a vibration sensor 2, an error vibration sensor 3, a vibration cancellation unit 4, an estimated secondary path filter unit 5, an adaptive algorithm unit 7, and a cancellation filter unit 8.

In the configuration described in the Background Art, a microphone is used for acquisition of a reference signal and an error signal, and a speaker is used for output of a cancellation signal. On the other hand, in the vibration cancellation apparatus according to the first embodiment, the vibration sensor 2 is used for acquisition of the reference signal, and the error vibration sensor 3 is used for acquisition of the error signal. The vibration sensor 2 and the error vibration sensor 3 are, for example, a vibration pickup or an acceleration sensor. Further, for the output of the cancellation signal, for example, the vibration cancellation unit 4 that is a vibration actuator or an exciter is used.

The vibration sensor 2 that acquires the reference signal is installed in a frame of the seat 1. The vibration sensor 2 may be installed on a front surface or a back surface of cloth or leather which is an exterior of the seat 1. Because it is better to install the vibration sensor 2 at a position close to a vibration source, the vibration sensor 2 is installed at a position close to a vibration source outside the seat 1, such as a foot or a back portion of the seat 1. Here, the seat 1 is a seat or a bed.

The error vibration sensor 3 that acquires the error signal is installed in the frame of the seat 1 in the same manner as the vibration sensor 2. The error vibration sensor 3 may be installed on the front surface or the back surface of cloth or leather which is the exterior of the seat 1. Because the error vibration sensor 3 is preferably installed at a position near the user's head, the error vibration sensor 3 is installed at a position close to the position where the head is placed when the user is seated, for example, near a headrest 11 of the seat 1.

The vibration cancellation unit 4 that generates cancellation vibration is installed in the frame of the seat 1 in the same manner as the vibration sensor 2. The vibration cancellation unit 4 may be installed on the front surface or the back surface of cloth or leather which is the exterior of the seat 1. Because the vibration cancellation unit 4 is preferably installed near the user's head, the vibration cancellation unit 4 is installed at a position close to the position where the head is placed when the user is seated, for example, near the headrest 11 of the seat 1.

The vibration sensor 2 acquires a reference signal x(t) (step S1). t is an index indicating time. The acquired reference signal x(t) is output to the estimated secondary path filter unit 5 and the cancellation filter unit 8.

The error vibration sensor 3 acquires the error signal e(t) (step S2). The acquired error signal e(t) is output to the adaptive algorithm unit 7.

The estimated secondary path filter unit 5 filters the input reference signal x(t) to generate a reference signal x′(t) of the adaptive algorithm (step S3). The generated reference signal x′(t) of the adaptive algorithm is output to the adaptive algorithm unit 7.

A transmission path from the vibration cancellation unit 4, which is a secondary sound source, to the error vibration sensor 3 is set as a secondary path. Further, a filter coefficient vector of the secondary path is C=[c₀, c₁, . . . , c_{N-1}]^{T}. N is a given positive integer. Further, a vector of the reference signal x(t) is X(t)=[x(t), x(t−1), . . . , x(t−N+1)]^{T}. Further, a vector of the reference signal x′(t) of the adaptive algorithm is X′(t)=[x′(t), x′(t−1), . . . , x′(t−N+1)]^{T}. In this case, the estimated secondary path filter unit 5, for example, calculates x′(t)=C^{T}X(t) to generate the reference signal x′(t) of the adaptive algorithm.

The adaptive algorithm unit 7, using an adaptive algorithm such as an LMS, an NLMS, a projection algorithm, or an RLS algorithm from the input reference signal x′(t) of the adaptive algorithm and the input error signal e(t), sequentially obtains a filter coefficient h(t) of the cancellation filter (step S4). See Reference 1 for details on the adaptive algorithm.

NPL 1: Isao Nakanishi, “Chapter 3 Adaptive Signal Processing,” [online], The Institute of Electronics, Information and Communication Engineers, “Knowledge Forest” Group 1—Volume 9—Chapter 3, [retrieved on Mar. 31, 2020], Internet <URL: http://www.ieice-hbkb.org/files/01/01gun_09hen_03m.pdf>

The adaptive algorithm unit 7 obtains a filter coefficient so that a squared average error of the error signal e(t) is minimized, for example. The obtained filter coefficient h(t) is output to the cancellation filter unit 8.

The filter coefficient h(t) is a vector and is, specifically, h(t)=[h0(t), h1(t), . . . , h_{N-}1(t)]^{T}. When the filter coefficient is updated by a Filtered-x LMS algorithm, the adaptive algorithm unit 7 obtains, for example, the filter coefficient h(t) using h(t)=h(t−1)+μe(t−1)x′(t−1). μ0 is a parameter for adjusting a convergence speed and estimation accuracy of an adaptive operation called a “step size parameter”, and is a predetermined number of 0<μ<2. As in this example, the adaptive algorithm unit 7 obtains the filter coefficient h(t) based on, for example, a previous time h(t−1), e(t−1), and x′(t−1).

The cancellation filter unit 8 filters the input reference signal x(t) using the input filter coefficient h(t) to generate a cancellation signal d′(t) (step S5). The generated cancellation signal d′(t) is output to the vibration cancellation unit 4. The cancellation signal can also be said to be a secondary sound source drive signal.

The vibration cancellation unit 4 generates cancellation vibration based on the input cancellation signal d′(t) (step S6).

The cancellation vibration can suppress vibration near the head part of the seat 1.

### Second Embodiment

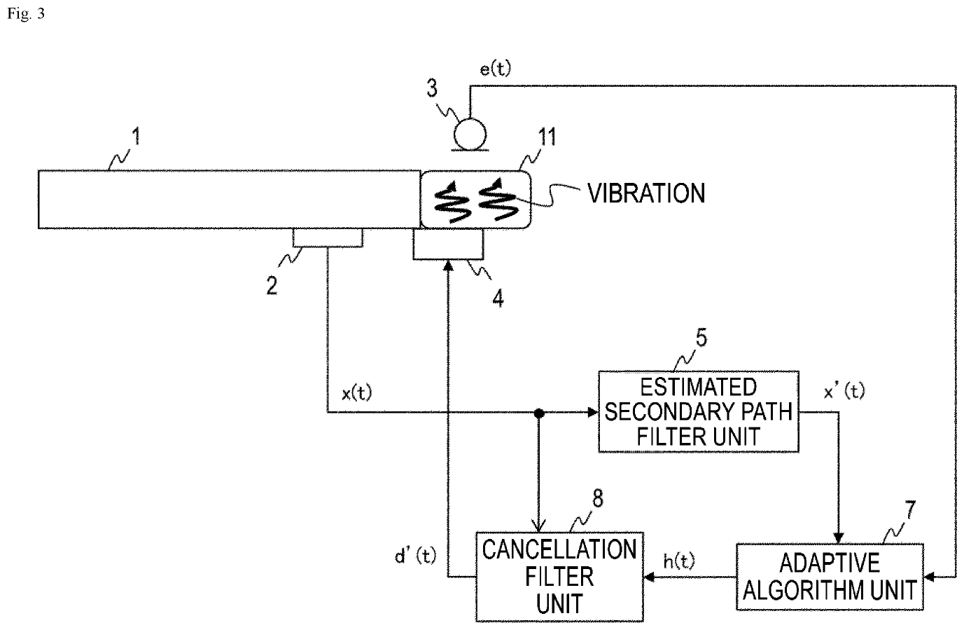

A vibration cancellation apparatus according to a second embodiment has a configuration in which a microphone is used as an error vibration sensor 3, as illustrated in FIG. 3. Other parts of the second embodiment are the same as those of the first embodiment.

More specifically, in the second embodiment, the error vibration sensor 3 which is a microphone is attached to a space around a head part or a seat surface of the seat 1. Thus, it is possible to minimize vibration of the air generated from the vibration of the seat 1.

### Third Embodiment

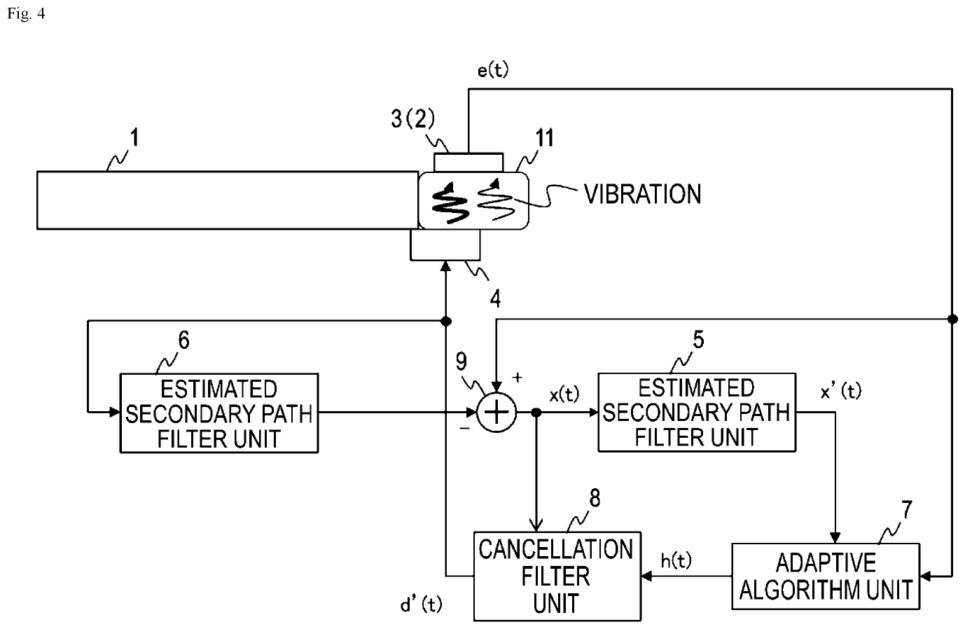

In a vibration cancellation apparatus according to a third embodiment, the vibration sensor 2 and the error signal sensor 3 in the vibration cancellation apparatus in the first embodiment are the same sensor, as illustrated in FIG. 4. In other words, in the third embodiment, the vibration sensor 2 and the error signal sensor 3 are shared as the same sensor. Thus, the number of vibration pickup sensors can be reduced by one.

Hereinafter, parts different from the first embodiment will be mainly described. Description of the same parts as in the first embodiment will be omitted.

In the example of FIG. 4, the vibration cancellation apparatus does not include a single vibration sensor 2, but the reference signal x(t) is obtained based on the error signal e(t) acquired from the error signal sensor 3 as will described below. Thus, it can be said that the error vibration sensor 3 is the same sensor as the vibration sensor 2.

The vibration cancellation apparatus of the third embodiment further includes an estimated secondary path filter unit 6 and a subtraction unit 9.

The cancellation signal d′(t) generated by the cancellation filter unit 8 is input to the estimated secondary path filter unit 6.

The estimated secondary path filter unit 6 filters the cancellation signal d′(t) to generate a filtered cancellation signal.

The filtered cancellation signal is input to the subtraction unit 9. The error signal e(t) is further input to the subtraction unit 9.

The subtraction unit 9 sets a signal obtained by subtracting the filtered cancellation signal from the error signal e(t) as the reference signal x(t). The generated reference signal x(t) is output to the estimated secondary path filter unit 5 and the cancellation filter unit 8.

A signal obtained by filtering the cancellation signal d′(t), which is a secondary sound source drive signal, using the estimated secondary path filter is equivalent to a cancellation signal at a position of the error vibration sensor 3. Thus, it is possible to reproduce vibration of the error vibration sensor 3 before cancellation through this processing.

### Fourth Embodiment

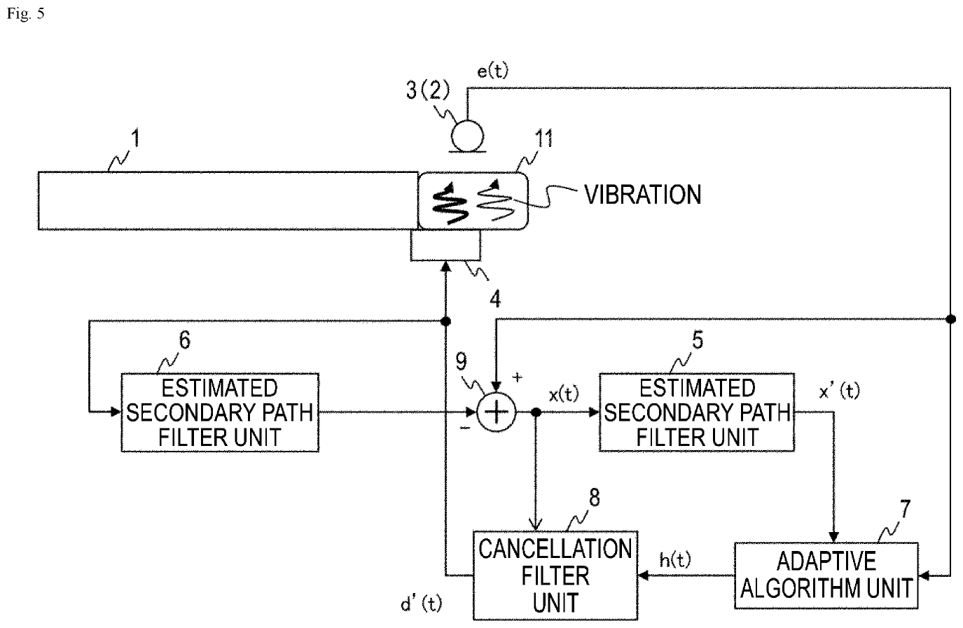

A vibration cancellation apparatus according to the fourth embodiment has a configuration in which a microphone is used as the error vibration sensor 3 in the vibration cancellation apparatus according to the third embodiment, as illustrated in FIG. 5. Other parts of the fourth embodiment are the same as those of the third embodiment.

More specifically, in the fourth embodiment, the error vibration sensor 3 which is a microphone is attached to a space around a head part of the seat 1 or to the seat. Thus, it is possible to minimize vibration of the air generated by the vibration of the seat 1.

### Fifth Embodiment

A vibration cancellation apparatus of a fifth embodiment has a configuration in which the noise canceling according to the Background Art is combined with the vibration cancellation apparatus of the second embodiment or the fourth embodiment. Other parts of the fifth embodiment are the same as those of the second or fourth embodiment.

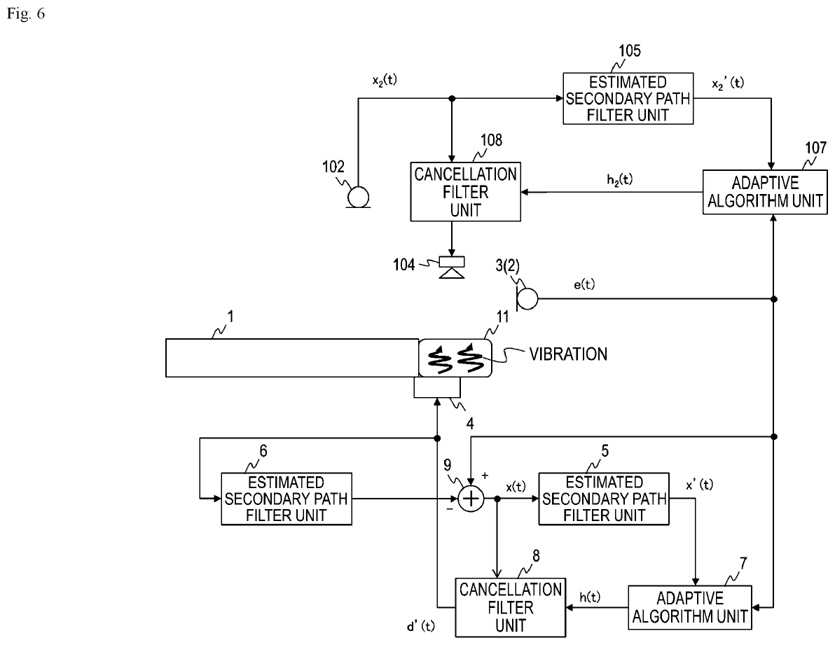

FIG. 6 illustrates a configuration in which the noise canceling according to the Background Art is combined with the vibration cancellation apparatus of the fourth embodiment, as an example of the vibration cancellation apparatus of the fifth embodiment.

Because processing of the vibration sensor 2, the error vibration sensor 3, the vibration cancellation unit 4, the estimated secondary path filter unit 5, the estimated secondary path filter unit 6, the adaptive algorithm unit 7, the cancellation filter unit 8, and the subtraction unit 9 is the same as that in the fourth embodiment, description thereof will be omitted. Hereinafter, processing of a reference microphone 102, a sound cancellation unit 104, an estimated secondary path filter unit 105, an adaptive algorithm unit 107, and a cancellation filter unit 108 will be described.

The processing of the reference microphone 102, the sound cancellation unit 104, the estimated secondary path filter unit 105, the adaptive algorithm unit 107, and the cancellation filter unit 108 is the same as that of the vibration sensor 2, the vibration cancellation unit 4, the estimated secondary path filter unit 5, the adaptive algorithm unit 7, and the cancellation filter unit 8, except that x(t) is x₂(t), x′(t) is x₂′(t), and h(t) is h₂(t).

The reference microphone 102 is disposed near a position where the user's head is placed when the user is seated. The reference microphone 102 acquires a reference signal x₂(t) (step S101). The acquired reference signal x₂(t) is output to the estimated secondary path filter unit 105 and the cancellation filter unit 108.

The error signal e(t) acquired by the error vibration sensor 3 is further output to the adaptive algorithm unit 107 as well as the adaptive algorithm unit 7 and the subtraction unit 9.

The estimated secondary path filter unit 105 filters the input reference signal x₂(t) to generate the reference signal x₂′(t) of the adaptive algorithm (step S103). The generated reference signal x₂′(t) of the adaptive algorithm is output to the adaptive algorithm unit 107.

The adaptive algorithm unit 107, by using an adaptive algorithm such as an LMS, an NLMS, a projection algorithm, or an RLS algorithm, sequentially obtains a filter coefficient h₂(t) of the cancellation filter from the input reference signal x₂′(t) of the adaptive algorithm and the input error signal e(t) (step S104). The obtained filter coefficient h₂(t) is output to the cancellation filter unit 108.

The cancellation filter unit 108 uses input filter coefficient h₂(t) to filter the input reference signal x₂(t) and generate a cancellation signal d₂′(t) (step S105). The generated cancellation signal d₂′(t) is output to the sound cancellation unit 104.

The sound cancellation unit 104, which is a speaker, generates a sound based on the input cancellation signal d₂′(t) (step S106).

With such a configuration, it is possible to cancel both vibration and noise propagating in the air.

In the adaptive algorithm of the fifth embodiment, normalization in a case in which an NLMS is used is a sum of powers of a reference signal for vibration control and a reference signal for noise control.

### Sixth Embodiment

A vibration cancellation apparatus of a sixth embodiment is a vibration cancellation apparatus in which the vibration sensor 2, the error vibration sensor 3, and the reference microphone 102 in the first to fifth embodiments are a plurality of sensors or a plurality of microphones.

The vibration cancellation apparatus of the sixth embodiment can improve the performance by multi-channel processing.

### Modification Example

Although embodiments of the present invention have been described above, a specific configuration is not limited to these embodiments, and it is obvious that appropriate design change without departing from the spirit of the present invention is also included in the present invention.

Various processing described in the embodiments may not only be executed in chronological order according to the order of the description, but may also be executed in parallel or individually according to a processing capacity of an apparatus that executes processing or as necessary.

For example, exchange of data may be performed directly between the constituent units of the cancellation apparatus, or may be performed via a storage unit (not illustrated).

### Program and Recording Medium

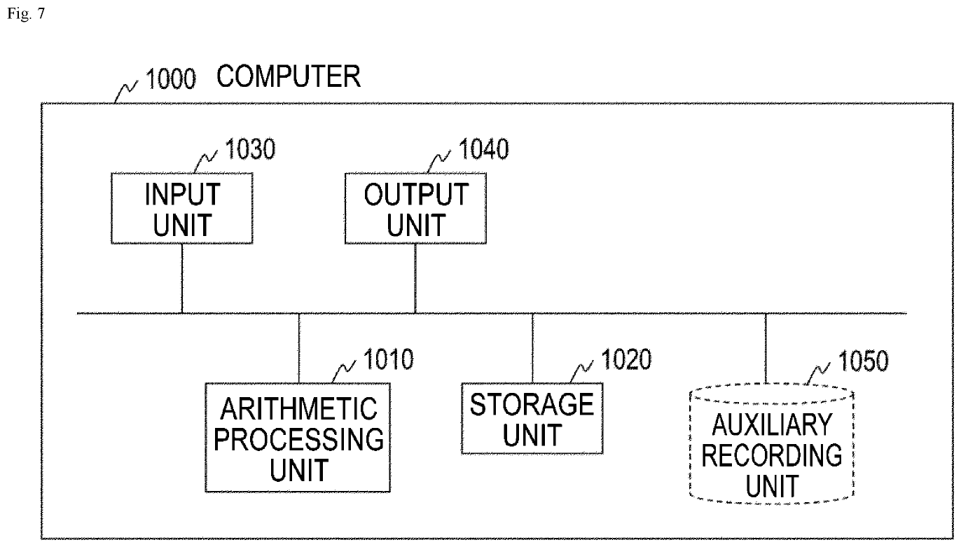

The processing of each unit of each apparatus described above may be realized by a computer, and in this case, processing content of the function that each apparatus should have is described in a program. By this program being loaded into a storage unit 1020 of the computer illustrated in FIG. 7 and operated in an arithmetic processing unit 1010, an input unit 1030, an output unit 1040, or the like, various processing functions in each of the apparatuses are realized on the computer.

A program in which processing content thereof is described can be recorded on a computer-readable recording medium. The computer-readable recording medium is, for example, a non-temporary recording medium, specifically, a magnetic recording apparatus or an optical disc.

Further, distribution of this program is performed, for example, by selling, transferring, or renting a portable recording medium such as a DVD or CD-ROM on which the program has been recorded. Further, the program may be distributed by being stored in a storage apparatus of a server computer and transferred from the server computer to another computer via a network.

The computer that executes such a program first temporarily stores, for example, the program recorded on the portable recording medium or the program transferred from the server computer in an auxiliary recording unit 1050, which is a non-temporary storage apparatus thereof. When the computer executes the processing, the computer reads the program stored in the auxiliary recording unit 1050, which is a non-temporary storage apparatus thereof, into the storage unit 1020 and executes processing according to the read program. Further, as another execution embodiment of the program, the computer may directly read the program into the storage unit 1020 from the portable recording medium and execute the processing according to the program Further, processing according to a received program may be sequentially executed each time the program is transferred from the server computer to the computer. Further, a configuration in which the above-described processing is executed by a so-called application service provider (ASP) type service for realizing a processing function according to only an execution instruction and result acquisition without transferring the program from the server computer to the computer may be adopted. It is assumed that the program in the present embodiment includes information provided for processing of an electronic calculator and pursuant to the program (such as data that is not a direct command to the computer, but has properties defining processing of the computer).

Further, although the present apparatus is configured by a predetermined program being executed on the computer in this embodiment, at least a part of these processing contents may be realized by hardware.

It is obvious that other changes can be made appropriately without departing from the spirit of the present invention.

1. A vibration cancellation method for canceling vibration arriving at a seat from outside of the seat, the vibration being transmitted to a user seated in the seat, the method comprising:
outputting, to cancel the vibration, a cancellation signal from a position close to a position where user's head is placed when the user is seated, the cancellation signal being obtained based on a reference signal and an error signal, the reference signal being obtained by a vibration sensor disposed at a position close to a vibration source outside the seat in the seat, the error signal being obtained by an error vibration sensor disposed at the position close to the position where user's head is placed when the user is seated in the seat.

2. The vibration cancellation method according to claim 1, wherein the reference signal is generated in response to the error signal.

3. The vibration cancellation method according to claim 1, wherein the error vibration sensor is a microphone.

4. The vibration cancellation method according to claim 3, further comprising:
outputting a cancellation signal obtained based on a reference signal and an error signal from a position close to a position where user's head is placed when a user is seated, to cancel a sound at the position close to the position where user's head is placed when the user is seated in the seat, the reference signal being obtained by a reference microphone disposed at the position close to the position where user's head is placed when the user is seated.

5. The vibration cancellation method according to claim 1, wherein each of the vibration sensor and the error vibration sensor is a plurality of sensors.

6. The vibration cancellation method according to claim 1,
wherein the vibration sensor is disposed at a foot or back portion of the seat, and
the error vibration sensor is disposed near a headrest of the seat.

7. A vibration cancellation apparatus for cancelling vibration arriving at a seat from outside of the seat, the vibration being transmitted to a user seated in the seat, the vibration cancellation apparatus comprising:
processing circuitry configured to
output, to cancel the vibration, a cancellation signal from a position close to a position where user's head is placed when the user is seated in the seat, the cancellation signal being obtained based on a reference signal and an error signal, the reference signal being obtained by a vibration sensor disposed at a position close to a vibration source outside the seat in the seat, the error signal being obtained by an error vibration sensor disposed at the position close to the position where user's head is placed when the user is seated in the seat.

8. A non-transitory computer readable medium that stores a program for causing a computer to execute processing of the vibration cancellation method according to claim 1.
